(19) United States
(12) Patent Application Publication
(10) Pub. No.: US 2007/0127926 A1
(43) Pub. Date: Jun. 7, 2007

(54) Free space optical conditioner

(76) Inventors: Fabio Marioni, Bosisio Parini (LC) (IT); Amoldo Valenzuela, Munich (IT)

Correspondence Address: NEIFELD IP LAW, PC, 4813-B EISENHOWER AVENUE, ALEXANDRIA, VA, 22304, US

(21) Appl. No.: 10/579,536

(22) PCT Filed: Nov. 17, 2004
(86) PCT No.: PCT/EP04/13042

§ 371 Date: Feb. 13, 2007

(30) Foreign Application Priority Data
Nov. 17, 2003 (IT) PCT/IT03/00742

(51) Int. Cl. H04B 10/00

(52) U.S. Cl. 398/118

(57) ABSTRACT

An optical communications terminal, comprising: an optical telescope (e.g. a dual mirror Ritchie-Chretien telescope); a transmitter unit including at least one transmitter coupled to source of optical signals; a receiver unit for receiving optical signals; an optical system defining a transmit optical path between the optical telescope and the transmitter unit, and defining a receive optical path between the optical telescope and the receiver unit; and a beacon detector for detecting beacon optical signals received at the optical telescope; characterised in that a beacon optical path between the optical telescope and the beacon detector comprises at least a portion of said transmit optical path and/or said receive optical path. In one embodiment, the transmitter unit, receiver unit and beacon detector are disposed at or adjacent the focal plane of the optical telescope, providing a compact arrangement suitable for usage in diverse environments (e.g. aircraft- or satellite-borne, as well as ground-based). In another aspect of the invention there is disclosed an optical communications terminal in which the transmitter unit comprises a plurality of transmitters, each transmitter being coupled to a respective source of optical signals. An optical free space communications system comprising two such coupled terminals is also disclosed.

The present invention relates to optical communications, and more particularly relates to high bandwidth free space optical communications.

The increased need for high bandwidth (high data rate) communication links induced by the recent growth of the internet and mobile communications has led to renewed interest in free space optical communication (Whipple, “Free space communications connects”, Photonics at work, October 1999). In free space optical communications the data are transmitted through a communication link between a transmitting station and a receiving station by a laser beam preferably having a wavelength of about 1550 nm without using a physical medium such as an optical fibre or the like. Depending on the weather conditions, communications links over a distance of several kilometres with a bandwidth of up to 2.5 Gbits per second have been demonstrated (P. F. Szajowski et al., “Key elements of high speed WTM terrestrial free space optical communication systems”, SPIE paper no. 3932-01). Such free space optical telecommunications links are especially useful for connecting facilities having high data transmission needs with one another, such as banks and universities in metropolitan areas. Another possible application is the high bandwidth live broadcasting of sports events, where an optical free space communication link can be set up temporarily at low cost.

In order to avoid health risks associated with laser radiation, the laser power has to be low (a few milliwatts) and the beam diameter must be large (about several tens of centimetres). To establish an optical free space communication link, the optical signal therefore has to be coupled out of an optical fibre network and directed with a transmission telescope over the desired distance directly to the receiving telescope where the received beam has to be concentrated and coupled into another optical network.

Various aspects of optical free space communication systems have been described. For example, EP-A-1,152,555 discloses electroforming replication techniques for the fabrication of optical mirror elements for high bandwidth free space optical communication. In addition, EP-A-1,172,949 discloses a free space optical communication system comprising a first unit having a first transmitter and a first receiver and a second unit having a second receiver corresponding to the first transmitter and a second transmitter corresponding to the first receiver, wherein the first and second transmitter and the first and second receiver comprise a reflective optical telescope, and optical fibre positioned in the focal region of the reflective optical telescope, and a positioning unit for moving the optical fibre in the direction of the optical axis of the telescope and within a plane perpendicular thereto. The unit is mounted on a tip-tilt positioning system electronically controlled (gimbal). This system provides an optical tracking function allowing a stable, secure, and high-bandwidth optical communication link.

U.S. Pat. No. 6,411,414 discloses an optical wireless link using wavelength division multiplexing. And EP-A-0,977,070 discloses an optical telescope with a shared (Tx/Rx) optical path in an optical communications terminal; however, a separate link is provided, taking the beacon signal from the secondary (dichroic) mirror.

Furthermore, a problem with available free space optical communication systems is a lack of power or redundancy in the signalling, making communications more vulnerable to atmospheric conditions. Also, the systems advanced heretofore also tend to involve complex optical arrangements for handling signals.

There is a need for optical communications terminals and communications systems that overcome the aforementioned problems and provide an improved performance. There is a need for terminals having optical systems of reduced complexity and component weight, so as to greater facilitate usage in diverse environments (e.g. aircraft- or satellite-borne, as well as ground-based).

The present invention provides an optical communications terminal, comprising: an optical telescope; a transmitter unit including at least one transmitter coupled to source of optical signals; a receiver unit for receiving optical signals; an optical system defining a transmit optical path between the optical telescope and the transmitter unit, and defining a receive optical path between the optical telescope and the receiver unit; and a beacon detector for detecting beacon optical signals received at the optical telescope; characterised in that a beacon optical path between the optical telescope and the beacon detector comprises at least a portion of said transmit optical path and/or said receive optical path.

Preferably, the transmitter unit, receiver unit and beacon detector are disposed at or adjacent the focal plane of the optical telescope.

In one embodiment: the system, the optical system includes a relay lens and a first mirror, and the optical path between said first mirror and the optical telescope is common to the transmit optical path, the receive optical path and the beacon optical path. The optical system may include a beamsplitter between the first mirror and the receiver unit, the beamsplitter, in use, passing receiver optical signals along the transmit optical path to the receiver unit and reflecting beacon optical signals along the beacon optical path to the beacon.

Preferably, the transmitter unit includes a plurality of transmitters.

Preferably, for the or each transmitter an aperture is provided in the first mirror, a separate transmit optical path thereby being provided from the or each transmitter to the optical telescope via a respective aperture. Preferably, the or each transmitter comprises the terminating portion of a single mode optical fibre, a collimating lens preferably being provided at said terminating portion in a respective transmit optical path. In the case of a plurality of transmitters, each transmitter may be fed by the same optical signal, or may be fed by a different optical signal. In one embodiment, there are three transmitters.

Preferably, the beacon optical path includes a second focussing lens between said beamsplitter and the beacon detector. Preferably, the beacon optical path includes a filter system between said second focussing lens and the beam detector, the filter system preferably including, in sequence, a filter passing a first predetermined frequency and a neutral density filter. The first predetermined frequency is, for example, 830 nm.

Preferably, the receiver unit includes one receiver for receiving optical signals at a second predetermined frequency, different to said first predetermined frequency, said second predetermined frequency preferably being 1550 nm. The receiver may comprise a terminating portion of a multimode optical fibre.

In accordance with another aspect of the invention there is provided an optical communications terminal, comprising: an optical telescope; a transmitter unit coupled to source of optical signals; a receiver unit for receiving optical signals; an optical system defining a transmit optical path between the optical telescope and the transmitter unit, and defining a receive optical path between the optical telescope and the transmitter unit; and characterised in that the transmitter unit comprises a plurality of transmitters, each transmitter being coupled to a respective source of optical signals.

In accordance with another aspect of the invention there is provided optical free space communications system, comprising: a first optical communications terminal, the first optical communications terminal being a terminal according to any of claims 1 to 30 of the appended claims; and a second optical communications terminal, the second optical communications terminal being a terminal according to any of claims 1 to 30 of the appended claims; wherein the first optical communications terminal and the second optical communications terminal are arranged whereby, in use, the transmitter unit of the first optical communications terminal may transmit said optical signals to the receiver unit of the second optical communications terminal and the transmitter unit of the second optical communications terminal may transmit said optical signals to the receiver unit of the first optical communications terminal.

An advantage of the present invention is that the same optical system that is used to send and receive high data rate optical signals is also used simultaneously by beacon optical signals for pointing, acquisition and tracking purposes.

Another advantage is that by disposing a greater proportion of the hardware in or near the focal plane, good optical alignment of the Tx and Rx beams can be attained and maintained.

A further advantage is that the use of multiple transmitters and multiple air paths enables a greater total power of signal to be employed. If several identical signal beams are sent, there is less susceptibility to error; and if several different signal beams are sent, the total data rate is higher.

Embodiments of the invention will now be described, by way of example, with reference to the accompanying drawings. In the following, various embodiments are described, including an optical communications terminal in accordance with one aspect of the invention and adapted to be mounted on the ground (hereafter “ground demonstrator”). The drawings are briefly described as follows.

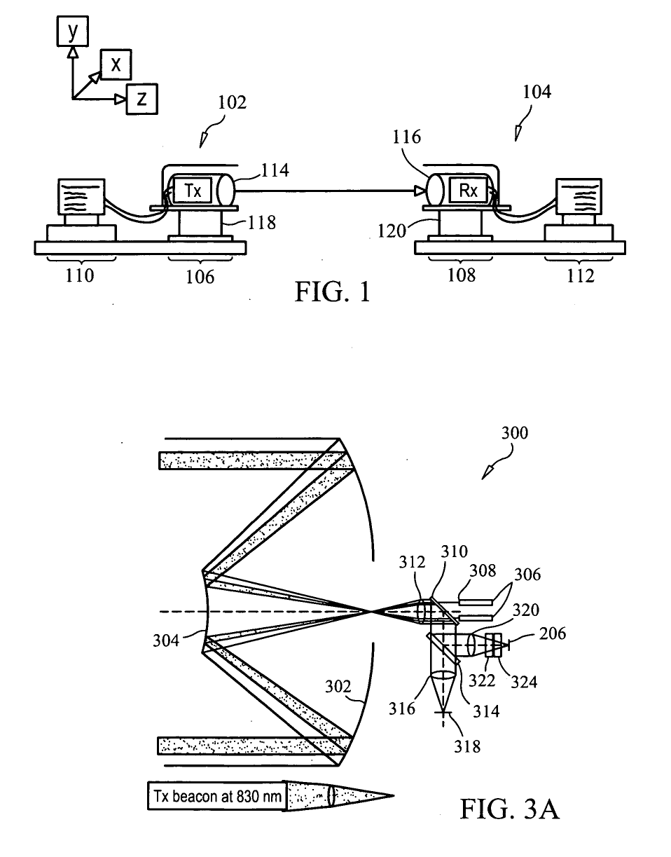

FIG. 1 is a schematic diagram of a free space optical communication system in accordance with one aspect of the invention.

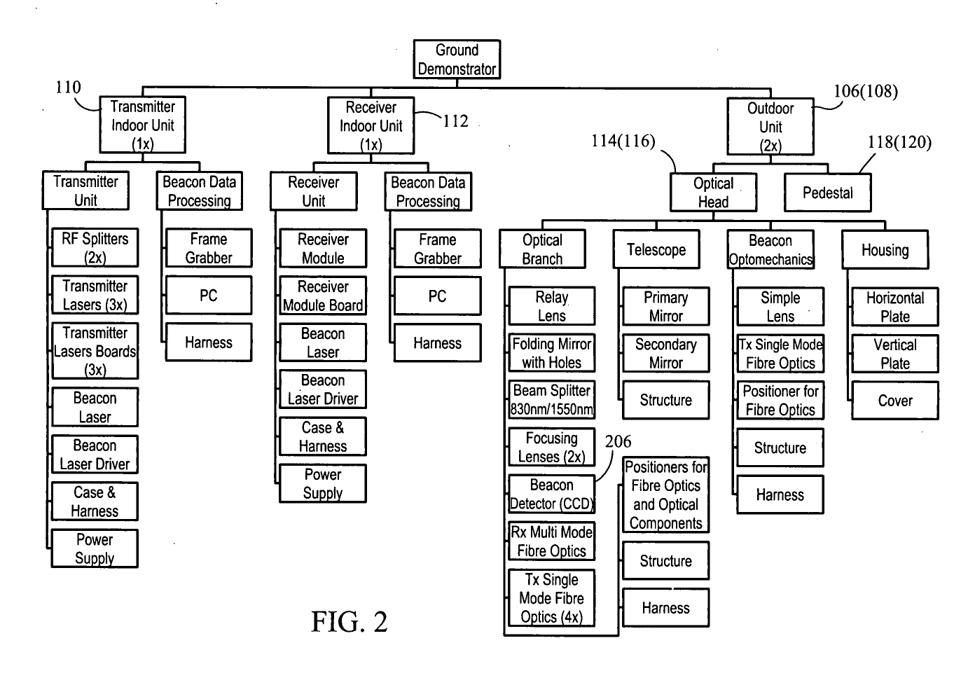

FIG. 2 is a hardware tree for the ground demonstrator in accordance with one aspect of the invention.

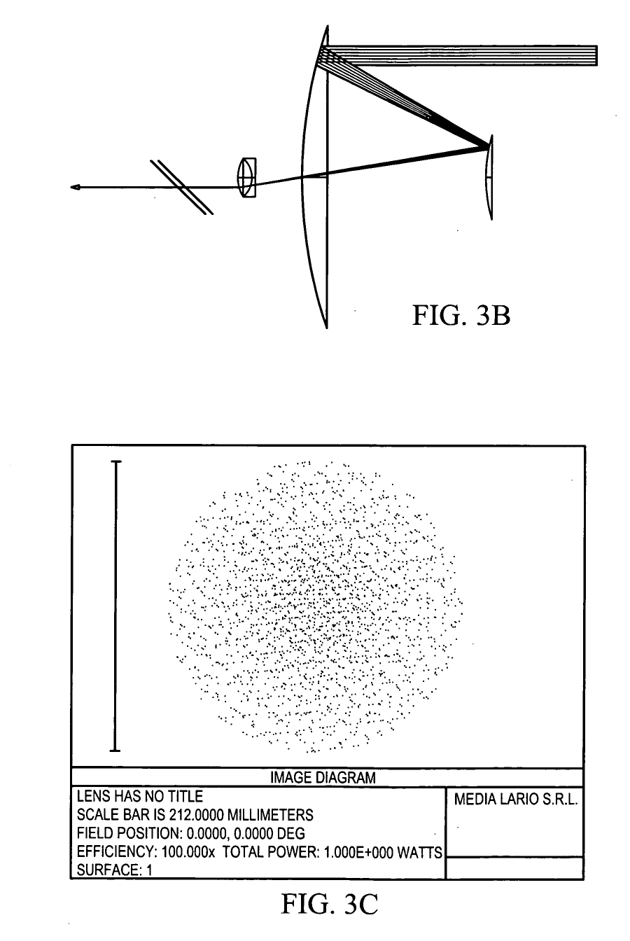

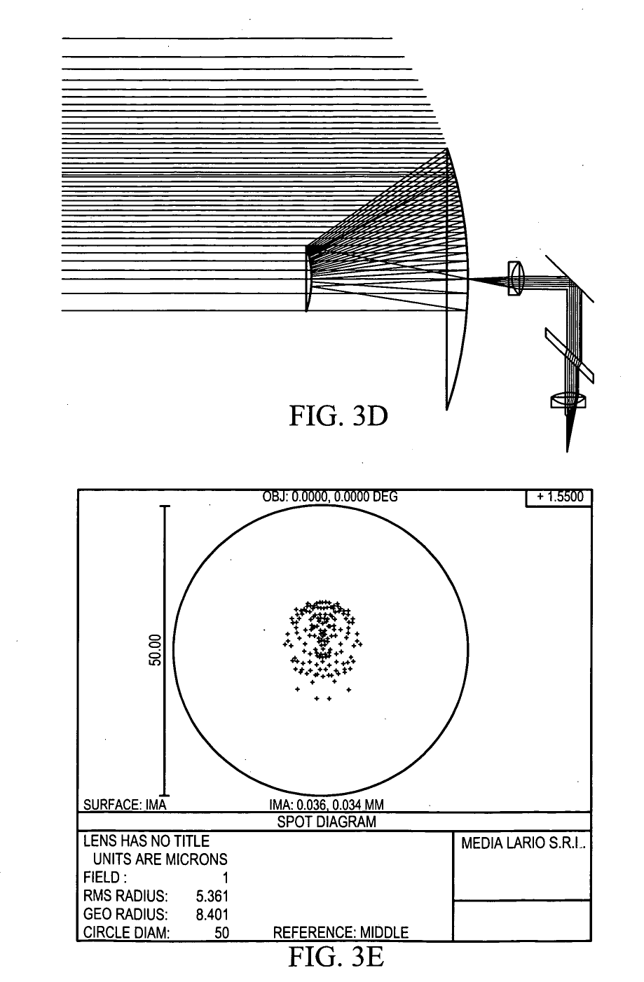

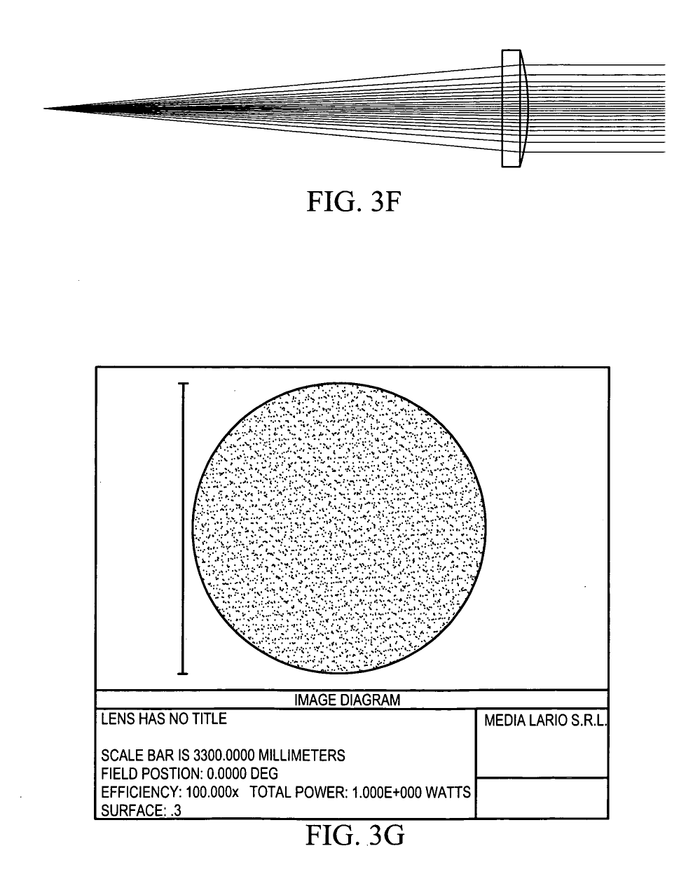

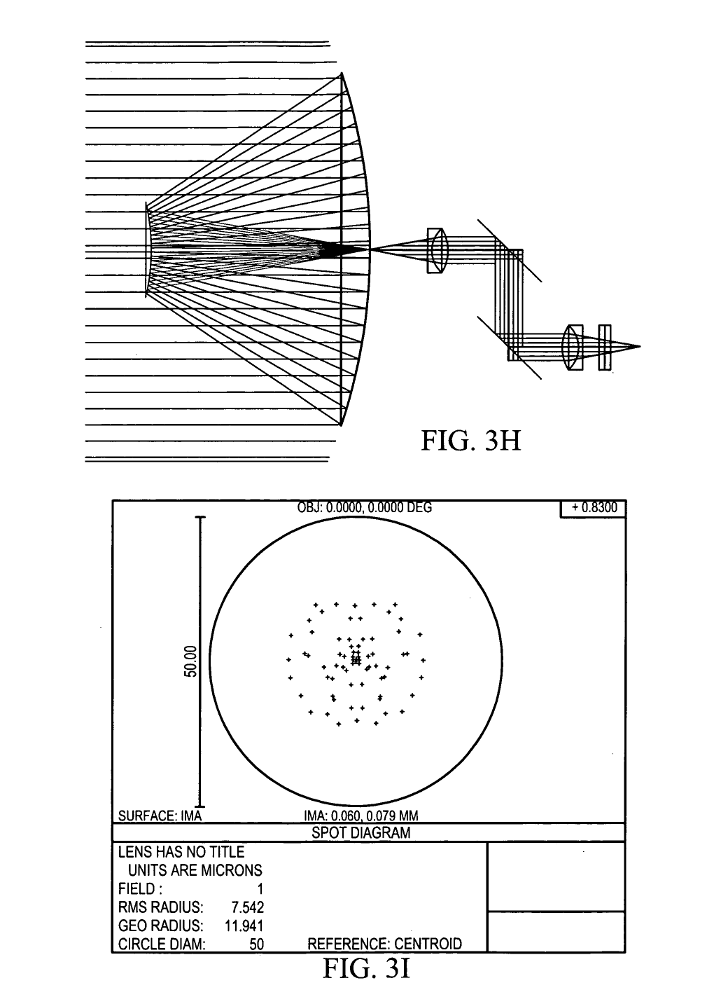

FIG. 3(a) is a schematic view of the optical configuration of the ground demonstrator.

FIG. 3(b) shows transmission at 1550 nm in the ground demonstrator: optical layout (only one of the 3 beams is shown).

FIG. 3(c) shows beam shape (1550 nm) at the Rx telescope (only one of the 3 beams is shown).

FIG. 3(d) shows reception at 1550 nm: optical layout (only one of the 3 beams is shown).

FIG. 3(e) shows reception at 1550 nm: spot diagram (only one of the 3 beams is shown).

FIG. 3(f) shows Transmission of the beacon at 830 nm: optical layout.

FIG. 3(g) shows beam shape (beacon at 830 nm) at the Rx telescope.

FIG. 3(h) shows reception of the beacon at 830 nm: optical layout.

FIG. 3(i) shows Reception of the beacon at 830 nm: spot diagram.

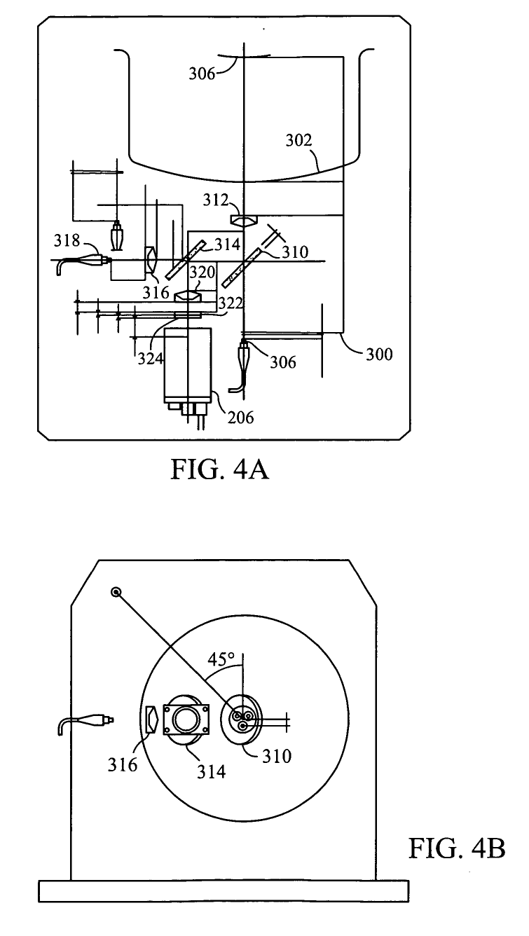

FIG. 4 shows the positions of the optical components (only one Tx is shown), (a) in longitudinal cross-section, and (b) in rear view.

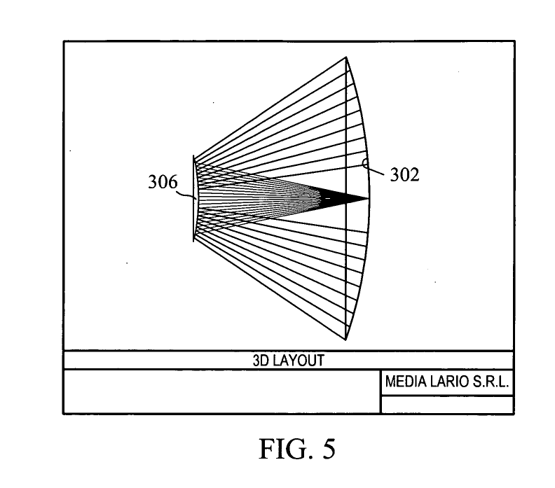

FIG. 5 shows the Optical layout of the R-C telescope.

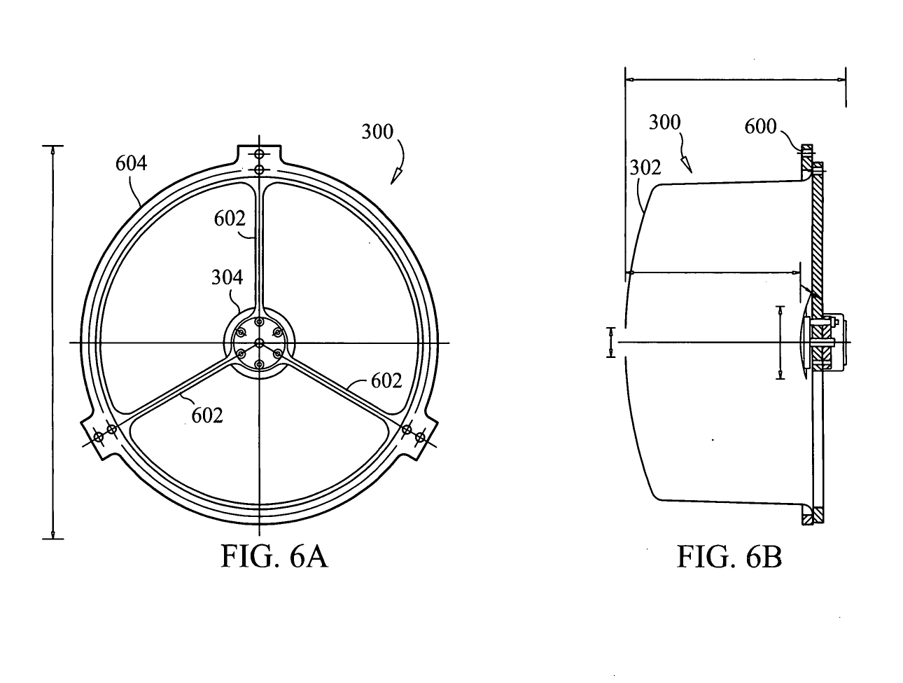

FIG. 6 shows the Telescope Assembly, (a) in longitudinal cross-section, and (b) in front view.

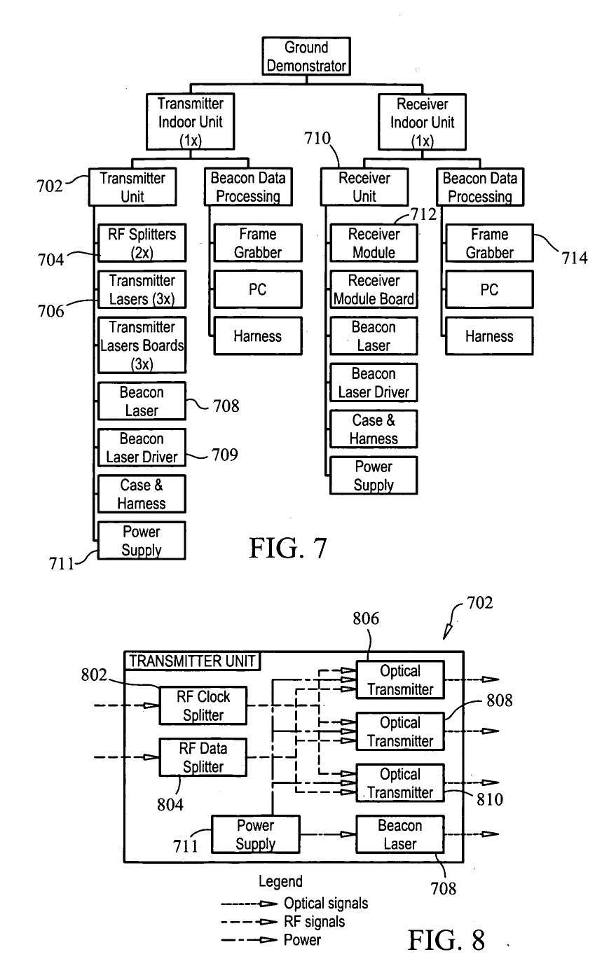

FIG. 7 shows the Hardware Tree for the Indoor Units for the ground demonstrator.

FIG. 8 shows the functional block diagram of the Transmitter for the ground demonstrator.

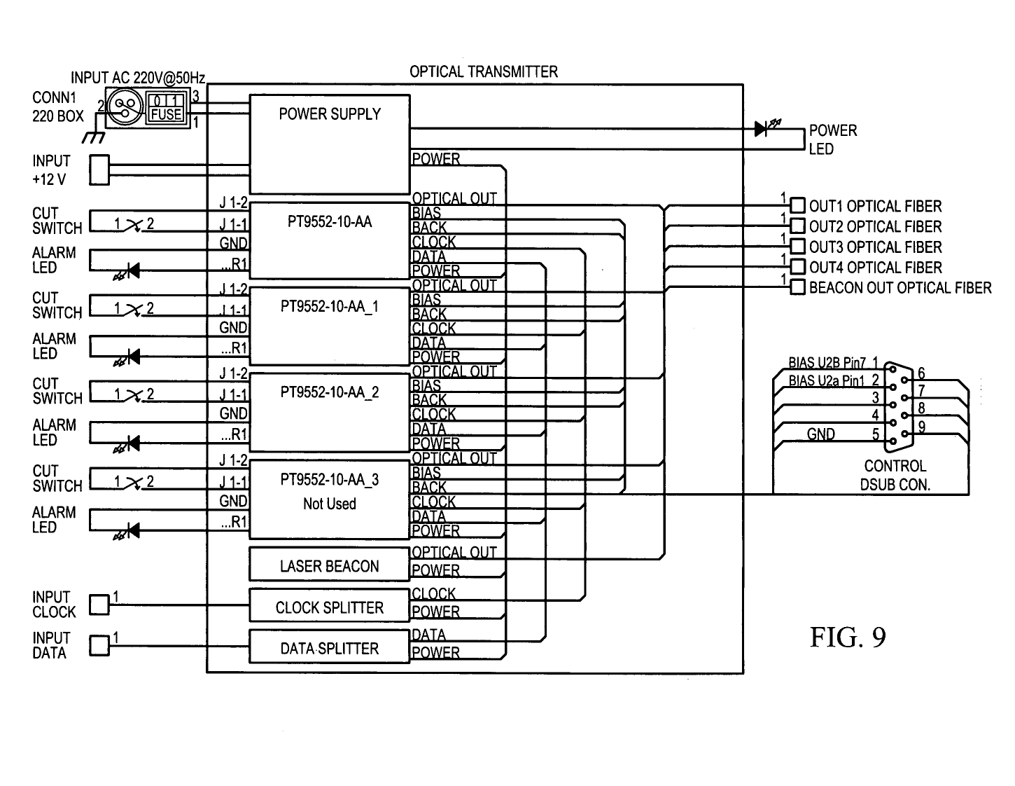

FIG. 9 shows the transmitter unit indoor cabling for the ground demonstrator.

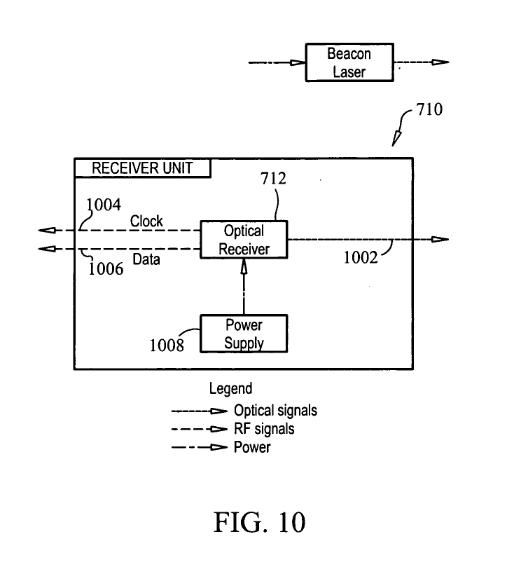

FIG. 10 shows the functional block diagram of the Receiver for the ground demonstrator.

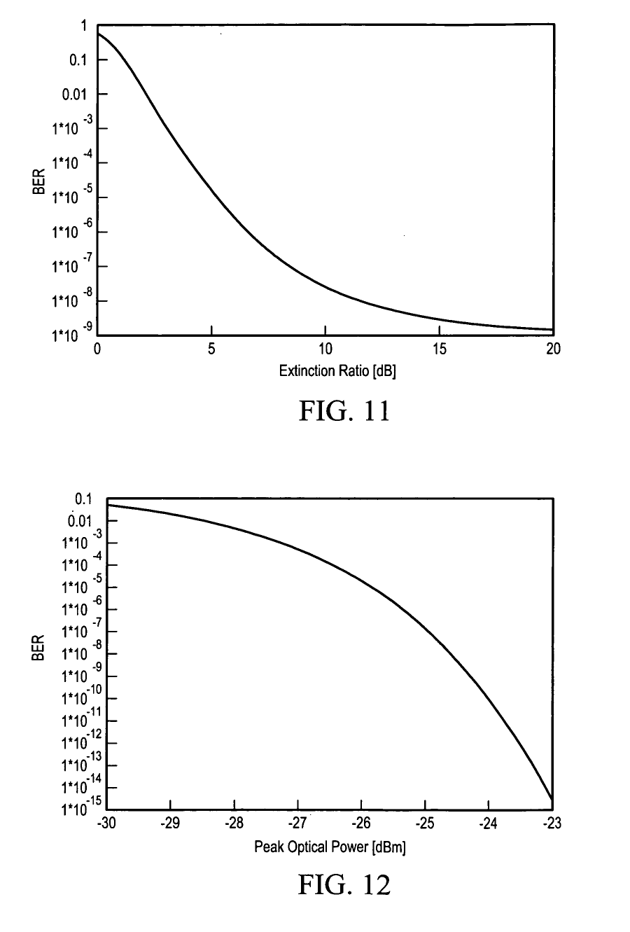

FIG. 11 shows bit error rate (BER) as a function of the extinction ratio at −25 dB peak received power for the ground demonstrator.

FIG. 12 shows BER as a function of the peak received power at 8.2 extinction ratio for the ground demonstrator.

Throughout this description, like numerals are used to denote like elements.

1. Introduction

There has been developed a low-cost lightweight terminal designed for Free Space Optics (FSO) communication, for example between collocated spacecrafts in geostationary orbit. Based on the use of the lightweight mirrors produced by Media Lario s.r.L's proprietary electroformed replication technology, the terminal presents the following advantages:
simple design with minimum number of components
compact and light mass system, based on advantages of Nickel replicated mirrors
large field of view in the focal plane of the telescope
easy access to focal plane for tracking and communication purposes
uniform power distribution inside the transmitted (Tx) beam; minimum losses
high coupling in reception of Rx beam in Rx multi-mode fibre optics
possibility to use gimbals systems for Pointing, Acquisition and Tracking without the necessity to include fast tracking devices
symmetrical system to allow the link between any couple of terminals of a given constellation

The optical communications terminal or ground demonstrator described herein is based on an architectural design, where appropriate using commercial components with the purpose of implementing the function of the architecture of the optical head at a low cost and therefore at a low risk. This is a necessary step in the development of a low cost lightweight Inter-Satellite link (ISL) terminal.

The following description is of a ground demonstration terminal designed for communication at 2.5 Gbit/s between ground stations at a relative distance of 1.1 km. Only minor modifications, simplifications and improvements are needed compared to the terminal design for the ISL scenario. The terminal configuration for the ground demonstrator uses “multi-beam transmission” (three Tx beams) for the compensation of atmospheric scintillation. Additionally, some optical bench components in the focal area of the telescopes have been adapted for use with Ritchey-Chrétien telescopes available from Media Lario; for this purpose three additional lenses have are used in order to extract the focus and make it accessible to accommodate the Rx fiber optics, the Tx fiber optics and the CCD camera. For the usage of the ground demonstrator under standard atmospheric environment and nominal operational conditions (ground application) with the same main technical solutions and concepts relative to the optical components and to the telecom equipment as for the Inter-Satellite link scenario, the tracking system may be simplified: it may be constituted by simple manual positioners to guarantee correct pointing and tracking only for the short periods during the optical verifications.

2. System Architecture

2.1 Overall Configuration

Referring to FIG. 1, two terminals, one transmitter 102 and one receiver 104, consist each respectively of two subsystems, i.e. the Outdoor Unit 106, 108 (composed by the Optical Head 114, 116 and the Pedestal) and the Indoor Unit 110, 112 (the Transmitter Indoor Unit for the Transmitter Terminal and the Receiver Indoor Unit for the Receiver Terminal), as discussed further hereinafter. The Optical Head 114, 116 is identical both for the Transmitter Terminal 102 and the Receiver Terminal 104; it comprises the Telescope, which is mounted on the Pedestal that provides manual gimbals movement for the alignment to the counter terminal. The Optical Bench includes all the components in the focal plane of the R-C telescope. The Optical Head 114, 116 is a compact assembly; it is suitably installed on an exposed site providing the necessary field of view with the remote terminal, without obscuration.

The Transmitter Indoor Unit 110 and the Receiver Indoor Unit 112 are connected respectively to the Transmitter and to the Receiver Optical Heads 114, 116, respectively.

The Indoor Units 110, 112 include all the electronics and the optoelectronics circuits and devices required to supply the required power, to convert the RF signals into the optical ones and vice versa and to drive the lasers.

2.2 Functional Description

FIG. 2 is a hardware tree for the ground demonstrator in accordance with one aspect of the invention.

The Optical Head (114, 116) is the core of the free-space connection between two terminals 102, 104. It is constituted mainly by a Ritchey-Chrétien telescope and by the opto-mechanical components to transmit and receive the optical signals from the Tx fiber optics to the Rx fiber optics.

The Transmitter Indoor Units (110) and the Receiver Indoor Units (112) supervise the operation of the Terminal and manages the control communication. The Indoor Units 110, 112 interface all the electronic sub-systems through a dedicated communication bus.

The main sub-systems of the Indoor Units (110, 112) are the Receiver Control Electronics and the Transmitter Control Electronics; they supervise the operation of Tx and Rx modules respectively by managing the required power, the enabling and the control signals and by monitoring their operational parameters in order to detect faults and failures. The transmitter control electronics also supervises the operation of the optical amplifier.

Pointing and acquisition are monitored by the CCD detector/camera 206 (in the Optical Head 114, 116) and the electronics required for its operation (included in the Receiver Indoor Unit); its goal is the determination of the signal power and centroid co-ordinates of the signal collected by the CCD camera 206.

The pointing is performed through the gimbals manual mechanism (not shown) of the Pedestal 118, 120 on which the optical head 114, 116 is mounted, based on the maintenance of the signal received by the CCD camera 206 on a reference position set under laboratory conditions.

The acquisition is performed automatically once the pointing has been performed, being the transmitter and the receiver optical axis of the terminal set parallel under laboratory conditions.

Apart from the previously standard terminal functional operation, if needed the optical components can be moved from their positions so that typical experimental tests will be set with the goal to test the optical performance and the characteristics of the terminal, its stability and its degree of optimisation.

2.3 Interfaces

The Terminal (102, 104) possesses the following interfaces:
Optical interface
RF interface
Power supply and grounding
Mechanical mounting

And only the first of these will be discussed, for brevity.

Optical Interface

The optical design of the terminal 102, 104 has been performed assuming that no protective optical glass will be present in front of the terminal.

The optical constraint is that the lines of view (200 mm diameter for the 1550 nm radiation and 9 mm for the 830 nm beacon radiation, plus divergence) between the two connected terminals must be maintained free from mechanical obstructions.

3. Optical Head (102, 104)

3.1 Overview on the Optical Head Configuration

FIG. 3(a) is a schematic view of the optical configuration of the ground demonstrator. The Optical Head configuration (the same for the Transmitter Terminal 102 and for the Receiver Terminal 104) is shown.

The optical head 114, 116 includes a telescope generally designated 300 in which the incoming and outgoing beams are reflected by primary mirror 302 and secondary mirror 304.

The transmitted beams are supplied by three SM fibre optic cables 306 terminated by three collimation lenses 308. The three beams pass through a hole mirror 310 having three respective holes (not shown), and pass through a relay lens 312 to the secondary mirror 304. The beams are thence reflected via primary mirror 302 on the outgoing transmission path from the optical head.

The incoming beam, via primary mirror 302 and secondary mirror 306, passes through relay lens 312 to the hole mirror 310. The hole mirror 312 reflects the beam transversely to a beamsplitter 314 that separates 830 nm and 1550 nm light radiation. At the beamsplitter 314, the 1550 nm light beam passes directly though, is focused by focusing lens 316 onto receiver multi-mode fibre optics 318 that is mounted on a x-y-z positioner (not shown).

Also at the beamsplitter 314, the 830 nm light beam is reflected at right angles to the 1550 nm beam, and after focusing by second focusing lens 320, passes though, in succession, a 830 nm filter 322 and a neutral density filter 324 and is received at a receiver CCD 206.

Item 328 denotes Tx single mode fibre optics (for the beacon at 830 nm), and item 330 a simple objective lens for focusing the beacon laser beam.

The following apply:
Each telescope 300 is used as transmitter and receiver at the same time.
In the focal plane of the telescope the series of optical components allow simultaneously to transmit and to receive optical signals at the identical wavelength of λ=1550 nm at a data rate of 2.5 Gbit/s.
One beacon (light beam) at a wavelength of 830 nm is used for pointing and acquisition purposes. Its divergence is always maintained as large as 3.0 mrad. It is transmitted through a separate simple lens with useful optical diameter of 9 mm.
In the focal plane of the R-C telescope 300 the Rx signals at 830 nm and 1550 nm are separated by the beamsplitter 314 and directed to the CCD 206 and to the Rx multi-mode fiber optics 318 respectively. An additional mirror 310 with three small holes separates mechanically the Rx section (CCD and Rx multi-mode fiber optics 50/125 μm) from the Tx laser beams (full beam divergence=190 μrad@ 1/e2 power angle; wavelength=1550 nm; power of 1 mW out of each of the three Tx single-mode fiber optics) assuring optical isolation.
The utilization of three transmitters reduces greatly the fluctuations of the intensity of the Rx beam caused by the turbulence of the atmosphere.
Three achromatic doublets 312, 316, 320 (diameter 25.4 mm) are used to extract the focus from the vertex of the primary mirror 302 to the area in the back part of the telescope 300 where the optical components can be accommodated.
The optical components are mounted on translation and rotation stages (not shown) to allow their correct fixation and alignment.

3.2 Optical Design

This will be described below with reference to the various optical components. In FIGS. 3(b) to 3(i) are shown various (Tx and Rx) ray pays and spot diagrams for the telescope 300 according to one embodiment.

FIG. 3(b) shows transmission at 1550 nm in the ground demonstrator: optical layout (only one of the 3 beams is shown). FIG. 3(c) shows beam shape (1550 nm) at the Rx telescope (only one of the 3 beams is shown). FIG. 3(d) shows reception at 1550 nm: optical layout (only one of the 3 beams is shown). FIG. 3(e) shows reception at 1550 nm: spot diagram (only one of the 3 beams is shown).

FIG. 3(f) shows Transmission of the beacon at 830 nm: optical layout. FIG. 3(g) shows beam shape (beacon at 830 nm) at the Rx telescope. FIG. 3(h) shows reception of the beacon at 830 nm: optical layout. FIG. 3(i) shows Reception of the beacon at 830 nm: spot diagram.

3.3 Telescope Focal Plane

3.3.1 The Optical Components

3.3.1.1 Position of the Optical Components

The position of the optical components is presented in FIG. 4.

The following should be noted:
The focus of the 830 nm beacon is focalised shifted (Δx=+55 μm; Δy=+55 μm ) with respect to the centre of the CCD. His is due to the fact that the optical axis of the Tx beacon is shifted (Δx=+123.7 mm; Δy=+123.7 mm) with respect to the optical axis of the Tx Ritchey-Chrétien telescope 300.
The fiber optics of the Tx beacon is 0.841 mm in intrafocal position to increase the divergence of the Tx beam; back focal length of the beacon lens is 46.641 mm at the reference wavelength of 830 nm.
The focal plane where the Rx fiber optics is placed (18.0 mm from the filter) is the plane when a collimated beam is collected by the Rx telescope.
The three arms of the spider do not intercept radiation of the three Tx beams that are placed at 60 deg with respect to the beams.

FIG. 5 shows the Optical layout of the R-C telescope.

3.3.1.2 The R-C Telescope

The telescope is a Ritchey-Chrétien reflector (cf. FIGS. 2 and 4) designed to have reduced dimensions, a large field of view and the possibility to accommodate the needed optical components in its focal plane. The telescope optical and dimensional characteristics are given below:
Optical configuration: Ritchey-Chrétien
Primary mirror: Diameter=200 mm (hole diameter=20 mm)
   Radius of curvature=315.8 mm concave
   Conic constant=1.0667 (hyperbola)
Secondary mirror: Diameter=52 mm
   Radius of curvature=110.8 mm convex
   Conic constant=−4.573 (hyperbola)
Distance between mirrors=120 mm
Distance between secondary mirror and focal plane=120 mm (without additional optical components in the focal plane)
Effective focal length of the telescope=500 mm
Effective numerical aperture=0.2
Effective focal ratio=f/2.5
Coating of primary and secondary mirrors=gold
Reflectivity of the gold layer (at λ=1550 nm and λ=830 nm)˜98%

FIG. 6 shows the Telescope Assembly, (a) in longitudinal cross-section, and (b) in front view. The telescope assembly is a compact unit, which can easily be handled without significant risks. In order to minimise the influence of the mechanical interface and environmental conditions, the telescope is mounted to the optical bench 600 by means of three stainless steel blades 602 distributed at a distance of 120° around the outer edge of the telescope (300). The blades are attached to the spider 604 on one side. The blades are arranged such that the stiffness in tangential and longitudinal direction of the mirror 302 is high while the stiffness in the radial direction is low, thus allowing for nearly unconstrained thermal expansion.

Returning to FIGS. 3(a) and 4, details of each of the optical components in the illustrated embodiment will be given.

3.3.1.3 Relay Lens and the Focusing Lenses

The Relay Lens 312 and Focusing Lenses 316, 320 are achromatic doublets introduced in the optical head to extract the focus of the Ritchey-Chrétien telescope 300 from its inner position to an outer position to accommodate the components of the focal plane. These lenses are identical. They have been designed for this specific purpose; additionally the beam emerging from the Relay Lens 312 is collimated with advantages during its integration and for its propagation through the beamsplitter 314.

Availability: the Relay Lens 312 and the Focusing Lenses 316, 320 are available from China Daheng Corporation (China). The technical characteristics of this specific product are the following:
Type: cemented achromatic doublet
Materials: LAKN22 and SFL6
Diameter: 25.4 mm +0.0/−0.2 mm
Clear aperture: 23 mm
Radii: 25 mm, 18 mm, 81.66 mm
Central thicknesses: 9 mm and 3 mm ±0.1 mm
Surface quality: 60-40
Focal length: 48 mm ±2%
Surface figure: 1.5 λ, (vis)
Coating: AR at 1550 nm
Back focal length_{@ λ=4550 nm}=31 mm.

3.3.1.4 The Hole Mirror

The Hole Mirror 310 has the purpose to reflect the Rx radiation at 830 nm and 1550 nm respectively to the CCD 206 and to the Rx multi-mode fiber optics 318, while the Tx radiation is transmitted through three holes of 3 mm in diameter of the mirror 310 itself. The amount of Rx power blocked by the holes is about 0.6 dB. The Hole Mirror 310 optical and dimensional characteristics are given below:
Coating: gold
Diameter: 50 mm
Number of holes: 3
Holes diameter: 3 mm

Availability: the Hole Mirror is available from Gestione Silo Sr.I. (Italy).

3.3.1.5 The Beamsplitter 830/1550 nm

The Beamsplitter 314 has a coating on the 45° facet so to reflect the 830 nm received signal to the CCD 206, and to transmit the 1550 nm signal to the Rx fiber optics 318. The Beamsplitter 314 is available (Part Number: 47-7437) from Optarius (UK).

3.3.1.6 Tx Collimation Lens

The Tx Collimation Lens 308 is a small lens placed just in front (3.644 mm) of each of the three Tx fiber optics to make the signal more converging (full beam divergence=190 μrad @ 1/e² power angle). In this way the Tx beams, whose divergence is due mainly to diffraction effects, have a very well corrected Gaussian profile. Advantages of this configuration are that only small areas (Ø˜12 mm each) of the Ritchey-Chrétien telescope 300 are used by the Tx beams (the telescope has a Wave Front Error WFE<λ/4 P-V in any circular area with Ø=20 mm) and the obscuration of the secondary mirror 304 is avoided.

Availability: the Tx Collimation Lens 308 is available (Code: A45-976) from Edmund Scientific (USA).

3.3.1.7 Rx MM Fiber Optics

The Rx MM fiber optics 318 is a standard multi-mode fiber optics (Corning® 50/125) used for telecommunication.

Availability: this fiber optics is manufactured by Corning (USA) and available from LIGHTECH (Italy)

3.3.1.8 Tx SM Fiber Optics for 1550 nm

The Tx SM fiber optics 306 for the transmission of the 1550 nm signal is a standard single-mode fiber optics (Corning® SMF-28™) used for telecommunication.

Availability: this fiber optics 306 is manufactured by CORNING (USA) and available from LIGHTECH (Italy).

3.3.1.9 Tx Beacon Simple Lens

The beacon is transmitted through a simple objective lens placed outside the R-C terminal. The divergence of the beacon of 3.0 mrad (full beam divergence @ 1 /e² power angle) is obtained by positioning of the fiber optics through which the beacon is emitted in intrafocal position.

Availability: the Tx Beacon Simple Lens is available (Code: A45-486) from Edmund Scientific (USA). The technical characteristics of this specific product are the following:

3.3.1.10 Tx SM Fiber Optics for the Beacon at 830 nm

The Tx fiber optics through which the beacon is emitted is a standard single-mode fiber optics (M® FS-SN-4224) used for telecommunication.

Availability: this fiber optics is manufactured by 3M (USA) and available from LIGHTECH (Italy).

3.3.1.11 Filter 830 nm

The high sensitivity of the CCD camera 206 (≈−95 dBm/px at 830 nm) requires avoiding as much as possible the presence of background radiation. An IR band bass rejection filter 322 has been therefore selected to be placed in front of the CCD. Considering that:
the stability of the wavelength of the selected 830 nm Tx laser is ±10 nm
the typical tolerance of the central wavelength of this is type of filters is about ±10 nm
the typical tolerance of the band pass (FWHM) of this is type of filters is about ±10 nm
   the filter band pass has been selected with enough bandwidth (FWHM=50 nm) to cover the above tolerances, but not too large to avoid radiation from background.

Availability: the Filter 830 nm is available (Part Number: 47-7436) from Optarius (UK).

3.3.1.12 Neutral Density Filter

The high sensitivity of the CCD camera 206 (≈−95 dBm/px at 830 nm), the background radiation of the sky and the of the sky and the high intensity of the radiation of the beacon require the utilisation of a filter to reduce the intensity of the radiation collected by the CCD camera. A neutral density filter 324 (in addition to the band pass filter 322 at 830 nm) is therefore placed in front of the CCD 206.

Availability: the Natural Density Filter is available (Part Number: FSR-OD300) from Newport (USA).

3.3.1.13 The CCD Camera

The selected CCD 206 has been chosen being available as off-the-shelf equipment while being sensitive at 830 nm wavelength (after removal of the internal IR cut filter).

Availability: the CCD Camera 206 (Model: XC-75CE (internal IR cut filter removed)) is available from Sony (USA).

3.3.2 The Mechanical Supports

3.3.2.1 Supports for the Relay Lens

The relay lens 312 is mounted on:
Translating lens mount for 1″ optics, manufactured by Thorlabs Inc. (USA), code LM1XY/M, catalogue 2003, page 117, that allows translation adjustments of ±1 mm in x and y.
Single axis steel translation stage, manufactured by Melles Griot (USA), code 07TES502 side drive, catalogue 2003, page 28.6, that allows translation of ±3 mm in z.

3.3.2.2 Supports for the Hole Mirror

The Hole Mirror 319 is mounted on:
Lens mount for 2″ optics, manufactured by Thorlabs Inc. (USA), code LMR2/M, catalogue 2003, page 97.
Two single axis steel translation stages, manufactured by Melles Griot (USA), code 07 TES 502 side drive, catalogue 2003, page 28.6, that allows translation of ±3 mm in x and y.

3.3.2.3 Supports for the Tx SM Fiber Optics for 1550 nm and for the Collimation Lens

Each of the three Collimation Lenses 308 is mounted inside a cylindrical tube connected to the corresponding Tx fiber optics 306. These three systems are then inserted inside a larger tube that is mounted on: Gimbal mount for 1″ optics, manufactured by Thorlabs Inc. (USA), code GM100/M, catalogue 2003, page 84, that allows tip/tilt with resolution of about 25 arcsec.

3.3.2.4 Supports for the Beamsplitter 830/1550 nm

The Beamsplitter 314 is mounted on: Lens mount for 2″ optics, manufactured by Thorlabs Inc. (USA), code LMR2/M, catalogue 2003, page 97.

3.3.2.5 Supports for the Focusing Lens of the CCD

The Focusing Lens 320 of the CCD 206 is mounted on: Translating lens mount for 1″ optics, manufactured by Thorlabs Inc. (USA), code LM1XY/M, catalogue 2003, page 117, that allows translation adjustments of ±1 mm in x and y.

3.3.2.6 Supports for the Focusing Lens of the Rx Fiber Optics

The Focusing Lens 316 of the Rx fiber optics 318 is mounted on: Translating lens mount for 1″ optics, manufactured by Thorlabs Inc. (USA), code LM1XY/M, catalogue 2003, page 117, that allows translation adjustments of ±1 mm in x and y.

3.3.2.7 Supports for the Filter at 830 nm and the Neutral Density Filter

The filters 322, 324 are mounted on a holder connected to the CCD camera 206.

3.3.2.8 Supports for the CCD Camera

The CCD camera 206 is mounted on: Single axis steel translation stage, manufactured by Melles Griot (USA), code 07TES502 side drive, catalogue 2003, page 28.6, that allows translation of ±3 mm in z.

3.3.2.9 Supports for the Rx Fiber Optics

The Rx fiber optics 318 is mounted on:
Fiber adapter, manufactured by Thorlabs (USA), code SM1FC, catalogue 2003, page 116.
Translation stage, manufactured by Thorlabs (USA), code ST1XY-S/M, catalogue 2003, page 123, that allows translation of ±3.25 mm in x and y.
Single axis steel translation stage, manufactured by Melles Griot (USA), code 07TES502 side drive, catalogue 2003, page 28.6, that allows translation of ±3 mm in z.

3.3.2.10 Supports for the Tx Beacon Simple Lens

The Beacon Lens 320 is mounted inside a cylindrical tube attached to the vertical plate of the optical head 114, 116.

3.3.2.11 Supports for the Tx SM Fiber Optics of the Beacon at 830 nm

The Tx fiber optics of the beacon is mounted on:
Fiber adapter, manufactured by Thorlabs (USA), code SM1FC, cat. 2003, page 116.
Translation stage, manufactured by Thorlabs (USA), code ST1XY-S/M, catalogue 2003, page 123, that allows translation of ±3.25 mm in X and Y.
Single axis steel translation stage, manufactured by Meiles Griot (USA), code 07TES502 side drive, cat. 2003, page 28.6, that allows translation of ±3 mm in Z.

3.3.2.12 Supports for Additional Filters

Free space in front of the focusing lenses and in front of the Tx fiber optics has been left to insert, if needed, additional filters in case excessive radiation from external sources not considered in the present embodiment that could prevent the correct performance of the system.

4. Pedestal

The Pedestal 118, 120 is the support on which the Optical Head 114, 116, respectively is mounted. It is very stiff and heavy and provides therefore a stable support for the optical head.

The pedestals 118, 120 provide an azimuth and elevation manual adjustment capability so that the terminal 102, 104 can be aligned with respect to the counter terminal 104, 102; the elevation and azimuth ranges are about ±200 mrad, quite large also to compensate possible misalignment during the initial installation of the terminals in the sites for the operational field tests.

The interface between the pedestal and the optical head is the horizontal aluminium plate of the Pedestal 118, 120 (with 6 holes Ø 8.5 mm) and the base plate of the Optical Head 114, 116 (with 6 holes M8).

5. Indoor Unit

This section describes the design of the optoelectronic equipment of the ground demonstrator. The design is based on off-the-shelf components as far as possible.

The hardware tree of the optoelectronic equipment is shown in FIG. 7. It mainly consists In three sections.
The transmitter unit 702 consists in two RF splitters 704 that divide the input clock and data into two pairs of three Identical signals that in turn are applied to three transmitter lasers 706. The unit also contains the beacon laser 708.
The receiver unit 710 contains the receiver 712 that converts the input optical signal into the RF clock and data signals.
The CCD camera and the frame grabber.

5.1 Transmitter Unit

The block diagram of the transmitter unit 702 is shown in FIG. 8. The input clock and data RF signals are split by two passive devices 802, 804 in two pairs of three identical signals that in turn are applied to three transmitter lasers.

The transmitter unit 702 also contains the beacon laser. As an option an external oft-the shelf optical amplifier can be used on one channel. In this case the other two channels are switched oft. The optical amplifier is considered an instrument rather than part of the optoelectronic equipment.

5.1.1 Radio Frequency Splitter

Two passive identical RF 1:4 splitters (not shown), as are well known in the art, are used to split the clock and the data signals into four channels. One of the channels is not used and terminated by a 50 Ω impedance.

The only main design challenge related to the splitter is the requirement to reduce to a minimum the relative phase shift of the signals in the different splitter arms.

5.1.2 Optical Transmitter

Each of the three optical transmitters 806, 808, 810 is made by an off-the-shelf transmitter laser mounted, by soldering, on a custom board.

5.1.2.1 Transmitter Laser

The laser transmitter 806, 808, 810 used is Photon Technology PT9552-6-10-AA-FC. It is a complete 24 pins transmitter that converts the input RF clock and data signals into a modulated 1550 nm laser beam launched into a single mode fiber optics pigtail.

5.1.2.2 Transmitter Laser Board

On the transmitter board two switches may be used on pins #5 and #6 whereas two output buffers on pins #2 and #3 allow the possible readout of the laser bias and laser current.

5.1.3 Beacon Laser Subassembly

The beacon laser subassembly Is made by an off-the-shelf laser mounted on an off-the shelf driving board.

5.1.3.1 Beacon Laser

The beacon laser 708 used is PD-LD Inc.'s PL83 series.

5.1.3.2 Beacon Laser Driver

The driving of the beacon laser and the control of its output optical power is accomplished by an off-the-shelf driver 709 (see FIG. 7), model CCA by Roithner Lasertechnik. The driver is available as a mounted printed circuit.

5.1.3.3 Integration of the Beacon Laser Subassembly

The beacon laser diode is integrated on the driver by direct soldering of its pins on the driver board. A twin cable internal to the transmitter unit is soldered on the driver power supply pin-through-holes and connected to the 5 V power supply connector of the power supply unit (see Section 5.1.4).

5.1.4 Power Supply

The power supply 711 accepts as input either 220 VAC or 12 VDC. The output power supply is at 5 VDC, 10 W.

5,1.5 Case and Harness

The receiver telecommunication equipment is housed in a standard case for a 19″ rack, 1 U. The transmitter indoor unit internal cable connections are shown in FIG. 9.

5.1.6 External Interfaces

A summary of the transmitter unit interfaces is listed in Table 5.5.

TABLE 5.5
Transmitter unit interfaces.

| Interface | Type | # | Description |
|---|---|---|---|
| Optical | | | |
| Transmitted | Output | 4 | Single mode fibre, FC connector |
| data | | | |
| Beacon | Output | 1 | Single mode fibre, FC connector |
| Spare | Output | 1 | Single mode fibre, FC connector |
| Electrical | | | |
| Clock | Input | 1 | Unbalanced, 50 Ω, SMA connector |
| Date | Input | 1 | Unbalanced, 50 Ω, SMA connector |
| Control | Output | 1 | D9 connector |
| Power supply | Input | 1 | 230 V_{AC} or 12 V_{DC} |
| Mechnical | | | |
| Case type | — | — | Rack 19″, 1U |

5.2 Optical Amplifier

As an option an external off-the-shelf bench-top optical amplifier (i.e. the optical EDFA, IPG Photonics EAD-1-C) can be used on one of the output optical channels (see FIG. 8). In this case the other two channels are switched off. Since the transmitter has a peak power of 3 dBm, the peak output of the amplifier is at 33 dBm equivalent to 2 W.

5.3 Receiver Unit

The block diagram of the receiver unit 710 is shown in FIG. 10. The input optical signal 1002 is de-modulated and the clock 1004 and data RF 1006 signals generated as output by the optical receiver 712. Refer to Section 5.1.3 for the beacon laser subassembly description.

5.3.1 Optical Receiver

The optical receiver 712 is made by an off-the-shelf receiver mounted, by soldering, on a custom board.

5.3.1.1 Receiver

The optical receiver 712 used is Photon Technology PT0236-6-FC. This is a complete receiver with data retiming and clock recovery based on an InGaAs APD and supply with a 50 μm core multimode fibre optics. FIG. 11 shows bit error rate (BER) as a function of the extinction ratio at −25 dB peak received power for the receiver in the ground demonstrator. FIG. 12 shows BER as a function of the peak received power at 8.2 extinction ratio for the receiver in the ground demonstrator.

5.3.1.3 Receiver Board

On the receiver board, an output buffers on pin #23 allows the possible readout of the average input optical power.

5.3.2 Power Supply

The power supply 1008 accepts as input either 220 Vac or 12 VDC. The output power supply is at 5 VDC, 10 W.

5.3.3 Case and Harness

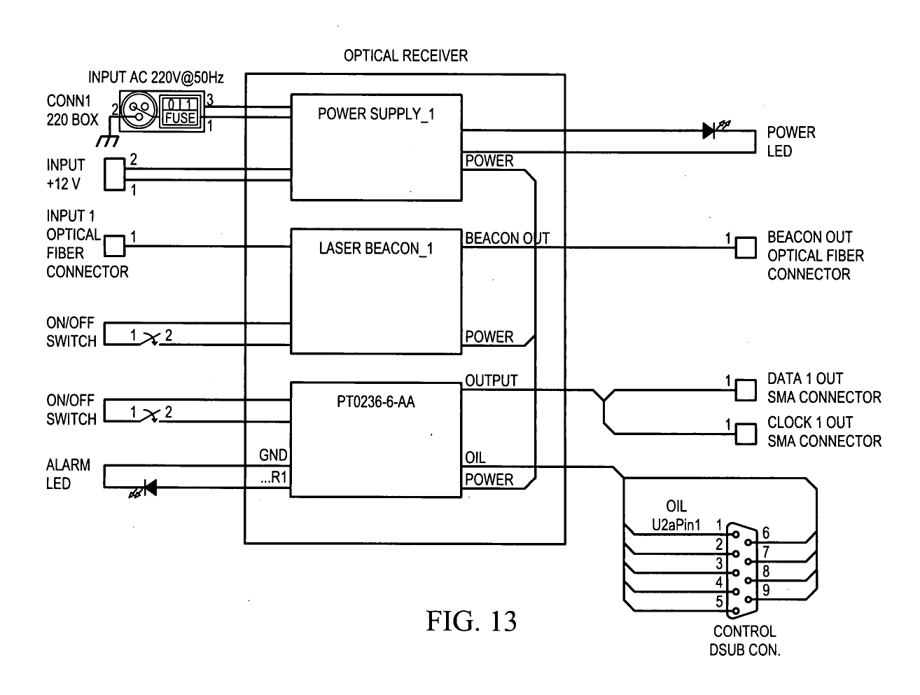

The receiver telecommunication equipment is housed in a standard case for a 19″ rack, 1 U. The receiver indoor unit internal cable connections are shown in FIG. 13.

5.3.4 External Interfaces

A summary of the receiver unit interfaces is listed in Table 5.9.

TABLE 5.9
Transmitter unit interfaces.

| Interface | Type | # | Description |
|---|---|---|---|
| Optical | | | |
| Received data | Input | 1 | 50 μm core multi mode fibre, |
| | | | FC connector |
| Beacon | Output | 1 | Single mode fibre, FC connector |
| Spare | Output | 1 | Single mode fibre, FC connector |
| Electrical | | | |
| Clock | Output | 1 | Unbalanced, 50 Ohm, SMA connector |
| Data | Output | 1 | Unbalanced, 50 Ohm, SMA connector |
| Control | Output | 1 | D9 connector |
| Power supply | Input | 1 | 230 Vac or 12 Vdc |
| Mechanical | | | |
| Case type | | — | Rack 19″, 1U |

5.4 CCD Camera and Frame Grabber

The CCD camera and the frame grabber are used for detection of the beacon signal. They have been both selected from off-the-shelf devices.

5.4.1 The CCD Camera

The CCD camera suitably used is Sony's XC-75CE. The scanning is at 625 lines operated at both 2:1 interlaced and non-interlaced mode.

5.4.2 The Frame Grabber

The frame grabber 714 (See FIG. 7) is suitably model IC-PCI-2.0 by Imaging Technology Inc. plus the AM-VS acquisition module by the same company.

6. Conclusions

The exemplary communications terminal has the following features:
A total number of 3 transmit beams is used to reduce the effects of the scintillation of the atmosphere.
Relay lenses have been introduced in order to allow the utilization of the desired R-C telescope design.
Commercial off-the-shelf components are used, where appropriate, for the electrical and electronics devices. It will be appreciated by persons skilled in the art that other equivalent components may be employed for space applications.
In the described embodiment, for the sake of illustration, a simple manual pointing and tracking system has been included to perform the optical communication tests at 2.5 Gbit/s; although it will be appreciated that non-manual systems may also be used.

These features do not fundamentally modify the architecture and the functionality of the terminal, compared with the ISL embodiment. They improve the availability of the link under ground environmental conditions.

### ANNEX 1

### LIST OF ACRONYMS

AC Alternate Current
AD Applicable Document
APD Avalanche Photo Diode
AR Anti Reflection
BER Bit Error Rate
CCD Charge Coupled Device
DC Direct Current
EDFA Erbium Doped Fiber Amplifier
ESA European Space Agency
ESTEC (ESA) European Space Research and Technology Centre
FO Fiber Optics
FSO Free Space Optics
FWHM Full Width Half Maximum
H/W Hardware
IR Infra Red
ISL Inter-satellite Link
ML Media Lario S.r.l.
MM Multi Mode
N.A. Numeric Aperture
NA Not Applicable
NRZ Non Return to Zero
OH Optical Head
OR Original
PC Personal Computer
P-V Peak to Valley
R-C Ritchey-Chrétien
RD Reference Document
RF Radio Frequency
Rx Receiver
SM Single Mode
Tx Transmitter
TTL Transistor-Transistor Logic
WFE Wavefront Error
ZEMAX® Focus Software Inc. Optical Analysis Package

1. An optical communications terminal, comprising:
an optical telescope;
a transmitter unit including at least one transmitter coupled to source of optical signals;
a receiver unit for receiving optical signals;
an optical system defining a transmit optical path between the optical telescope and the transmitter unit, and defining a receive optical path between the optical telescope and the receiver unit; and a beacon detector for detecting beacon optical signals received at the optical telescope;
characterised in that a beacon optical path between the optical telescope and the beacon detector comprises at least a portion of said transmit optical path and/or said receive optical path.

2. The terminal of claim 1, wherein the transmitter unit, receiver unit and beacon detector are disposed at or adjacent the focal plane of the optical telescope.

3. The terminal of claim 1, wherein the optical system includes a relay lens and a first mirror, and the optical path between said first mirror and the optical telescope is common to the transmit optical path, the receive optical path and the beacon optical path.

4. The terminal of claim 3, wherein the optical system includes a beamsplitter between the first mirror and the receiver unit, the beamsplitter, in use, passing receiver optical signals along the transmit optical path to the receiver unit and reflecting beacon optical signals along the beacon optical path to the beacon.

5. The terminal of claim 1, wherein the transmitter unit includes a plurality of transmitters.

6. The terminal of claim 1, wherein for at least one of said at least one transmitter an aperture is provided in the first mirror, a separate transmit optical path thereby being provided from at least one of said at least one transmitter to the optical telescope via a respective aperture.

7. The terminal of claim 1, wherein said at least one transmitter comprises the terminating portion of a single mode optical fibre, a collimating lens preferably being provided at said terminating portion in a respective transmit optical path.

8. The terminal of claim 5, wherein each transmitter is fed by the same optical signal.

9. The terminal of claim 5, wherein each transmitter is fed by a different optical signal.

10. The terminal of claim 5, wherein there are three transmitters.

11. The terminal of claim 4, wherein the beacon optical path includes a second focussing lens between said beamsplitter and the beacon detector.

12. The terminal of claim 11, wherein the beacon optical path includes a filter system between said second focussing lens and the beam detector, the filter system preferably including, in sequence, a filter passing a first predetermined frequency and a neutral density filter.

13. The terminal of claim 11, wherein the first predetermined frequency is 830 nm.

14. The terminal of claim 1, wherein, the receiver unit includes one receiver for receiving optical signals at a second predetermined frequency, different to said first predetermined frequency, said second predetermined frequency preferably being 1550 nm.

15. The terminal of claim 14, wherein the receiver comprises a terminating portion of a multimode optical fibre.

16. An optical communications terminal, comprising:
an optical telescope;
a transmitter unit coupled to source of optical signals;
a receiver unit for receiving optical signals;
an optical system defining a transmit optical path between the optical telescope and the transmitter unit, and defining a receive optical path between the optical telescope and the transmitter unit; and
characterised in that the transmitter unit comprises a plurality of transmitters, each transmitter being coupled to a respective source of optical signals.

17. The terminal of claim 16, wherein for at least one of said plurality of transmitters an aperture is provided in the first mirror, a separate transmit optical path thereby being provided from said at least one of said plurality of transmitters to the optical telescope via a respective aperture.

18. The terminal of claim 16, wherein at least one of said plurality of transmitters comprises the terminating portion of a single mode optical fibre, a collimating lens preferably being provided at said terminating portion in a respective transmit optical path.

19. The terminal of claim 16, wherein each transmitter is fed by the same optical signal.

20. The terminal of claim 16, wherein each transmitter is fed by a different optical signal.

21. The terminal of claim 16, wherein there are three transmitters.

22. The terminal of claim 16, further including a beacon detector for detecting beacon optical signals received at the optical telescope.

23. The terminal of claim 22, wherein the transmitter unit, receiver unit and beacon detector are disposed at or adjacent the focal plane of the optical telescope.

24. The terminal of claim 22, wherein the optical system includes a relay lens and a first mirror, and the optical path between said first mirror and the optical telescope is common to the transmit optical path, the receive optical path and the beacon optical path.

25. The terminal of claim 24, wherein the optical system includes a beamsplitter between the first mirror and the receiver unit, the beamsplitter, in use, passing receiver optical signals along the transmit optical path to the receiver unit and reflecting beacon optical signals along the beacon optical path to the beacon.

26. The terminal of claim 22, wherein the beacon optical path includes a second focussing lens between said beamsplitter and the beacon detector.

27. The terminal of claim 22, wherein the beacon optical path includes a filter system between said second focussing lens and the beam detector, the filter system preferably including, in sequence, a filter passing a first predetermined frequency and a neutral density filter.

28. The terminal of claim 22, wherein the first predetermined frequency is 830 nm.

29. The terminal of claim 22, wherein the receiver unit includes one receiver for receiving optical signals at a second predetermined frequency, different to said first predetermined frequency, said second predetermined frequency preferably being 1550 nm.

30. The terminal of claim 29, wherein the receiver comprises a terminating portion of a multimode optical fibre.

31. An optical free space communications system, comprising:
a first optical communications terminal, the first optical communications terminal being a terminal according to any of the preceding claims; and
a second optical communications terminal, the second optical communications terminal being a terminal according to claim 1;
wherein the first optical communications terminal and the second optical communications terminal are arranged whereby, in use, the transmitter unit of the first optical communications terminal may transmit said optical signals to the receiver unit of the second optical communications terminal and the transmitter unit of the second optical communications terminal may transmit said optical signals to the receiver unit of the first optical communications terminal.

32. A method of making an optical communications terminal, comprising:
providing an optical telescope;
providing a transmitter unit including at least one transmitter coupled to source of optical signals;
providing a receiver unit for receiving optical signals;
providing an optical system defining a transmit optical path between the optical telescope and the transmitter unit, and defining a receive optical path between the optical telescope and the receiver unit;
providing a beacon detector for detecting beacon optical signals received at the optical telescope; and
characterised in that a beacon optical path between the optical telescope and the beacon detector comprises at least a portion of said transmit optical path and/or said receive optical path.

33. A method of using an optical communications terminal, said optical communications terminal comprising:
an optical telescope;
a transmitter unit including at least one transmitter coupled to source of optical signals;
a receiver unit for receiving optical signals;
an optical system defining a transmit optical path between the optical telescope and the transmitter unit, and defining a receive optical path between the optical telescope and the receiver unit; and
a beacon detector for detecting beacon optical signals received at the optical telescope;
characterised in that a beacon optical path between the optical telescope and the beacon detector comprises at least a portion of said transmit optical path and/or said receive optical path; and
said method comprising receiving optical signals in said receiver unit.

34. A method of making an optical communications terminal, comprising:
providing an optical telescope;
providing a transmitter unit coupled to source of optical signals;
providing a receiver unit for receiving optical signals;
providing an optical system defining a transmit optical path between the optical telescope and the transmitter unit, and defining a receive optical path between the optical telescope and the transmitter unit; and
characterised in that the transmitter unit comprises a plurality of transmitters, each transmitter being coupled to a respective source of optical signals.

35. A method of using an optical communications terminal, said optical communications terminal comprising:
an optical telescope;
a transmitter unit coupled to source of optical signals;
a receiver unit for receiving optical signals;
an optical system defining a transmit optical path between the optical telescope and the transmitter unit, and defining a receive optical path between the optical telescope and the transmitter unit;
characterised in that the transmitter unit comprises a plurality of transmitters, each transmitter being coupled to a respective source of optical signals; and
said method comprising receiving optical signals in said receiver unit.
